(19) United States
(12) Patent Application Publication
(10) Pub. No.: US 2013/0271359 A1
(43) Pub. Date: Oct. 17, 2013

(54) MULTI-MONITOR DISPLAY SYSTEM

(71) Applicants: HUNG-CHI HUANG, Tu-Cheng (TW); CHING-JOU CHEN, Tu-Cheng (TW)

(72) Inventors: HUNG-CHI HUANG, Tu-Cheng (TW); CHING-JOU CHEN, Tu-Cheng (TW)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/587,943

(22) Filed: Aug. 17, 2012

(30) Foreign Application Priority Data
Apr. 16, 2012 (TW) 101113534

(51) Int. Cl. G09G 5/00

(52) U.S. Cl. 345/156; 345/1.1

(57) ABSTRACT

A multi-monitor display system includes a main monitor, at least one secondary monitor, a main input device, at least one secondary input device, a storage module, and a control module. The storage module stores a plurality of display modes of the main monitor and the secondary monitor, and a table that defining the display contents of the main monitor and the at least one secondary monitor in each display mode, which of the at least one secondary input device is enabled in each display mode, and which of the secondary monitor can be operated by the enabled input device in corresponding display mode. The control controls the main monitor and the at least one secondary monitor to display in a selected mode, and controls which of the main input device and the at least one secondary input device to operate the monitors according to the table.

### BACKGROUND

1. Technical Field

The present disclosure relates to multi-monitor display systems, and particularly, to a multi-monitor display system in which multi displays associate with multi input devices.

2. Description of Related Art

Multi-monitor display systems, such as, computer systems with more than one display/monitor, can offer more display area to display more information, and become more and more prevalent. However, in a multi-monitor display system, only one input device, such as a mouse, is used for operating all the multiple monitors/displays, this is inefficient.

Therefore, what is needed is a means to solve the problems described above.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of a multi-monitor display system in accordance with an exemplary embodiment.

FIGS. 2A-2C illustrate different display modes of the exemplary multi-monitor display system of FIG. 1.

### DETAILED DESCRIPTION

Embodiments of the present disclosure will now be described in detail, with reference to the accompanying drawings.

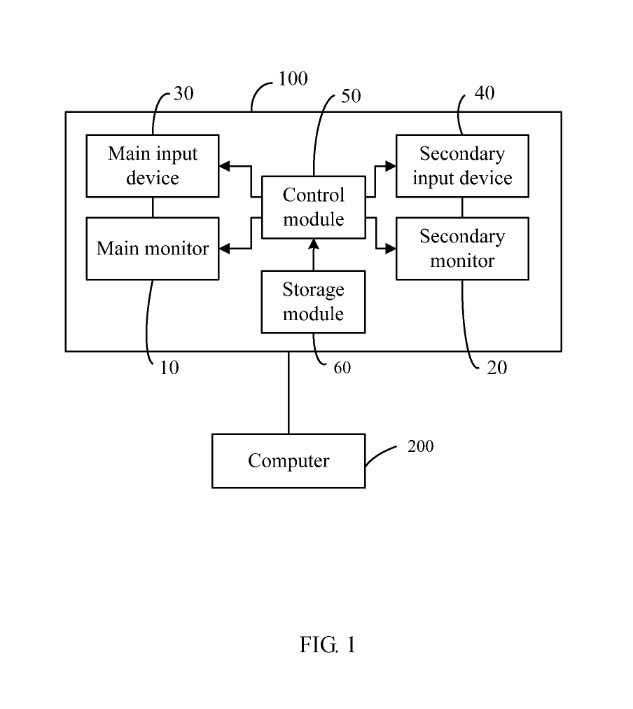

FIG. 1 illustrates a multi-monitor display system 100 in accordance to one embodiment. The multi-monitor display system 100 is connected to a computer 200. The computer 200 includes a main monitor 10, at least one secondary monitor 20, a main input device 30, at least one secondary input device 40, a storage module 50, and a control module 60. The main monitor 10, each of the at least one secondary monitor 20, the main input device 30, and each of the at least one secondary input device 40 are designated with a unique identifier. In the embodiment, the main input device 30 is connected to the main monitor 10, and each of the at least one secondary input device 40 is connected to one of the at least one secondary monitor 20. In the embodiment, the main input device 30 and the at least one secondary input device 30 may be mouse, keyboards, or touch panels, the main input device 30 is always in an enabled state and configured to control the operations at least on the main monitor 10, and each of the secondary input device 40 includes an enabled state and an disabled state.

The storage module 50 stores several display modes of the main monitor and the at least one secondary monitor, and a table that defines the display contents of the main monitor 10 and the at least one secondary monitor 20 in each display mode. In the embodiment, the display modes stored in the storage module 50 include a hierarchical mode, an extension mode, and a clone mode, and the table defines that in the hierarchical mode, the display content of the main monitor 10 is all the applications running in the computer 200, and the display content of the secondary monitor 20 is one of the above application displayed in the main monitor 10. The table further defines that in the extension mode, the display content of the main monitor 10 and the secondary monitor 20 is cooperatively displaying an integral image of the applications running on the computer 200, and in the clone mode, the display content of the main monitor 10 and the secondary monitor 20 is same and synchronous. In addition, the table further defines which of the at least one secondary input device 40 is enabled in each display mode and which of the secondary monitor can be operated by the enabled input device in the corresponding display mode. In this embodiment, in each display mode, the main display 10 always displays all the applications running on the computer 200.

The main input device 30 is further configured to be operated by an operator of the system 100 to select the display mode for the main monitor 10 and the secondary monitor 20 to be used.

The control module 60 controls the main monitor 10 and the selected secondary monitor 20 to display in the format according to the selected display mode. In addition, the control module 60 further controls the secondary input device 40 to switch between an enabled state and a disabled state according to the selected display mode. In this embodiment, the control module 60 recognizes the main monitor 10, the at least one secondary monitor 20, the main input device 30, and the at least one secondary input device 40 by the unique identifiers.

In detail, in the hierarchical mode, the control module 60 controls the main monitor 10 to display all the applications running on the computer 200, and controls the secondary monitor 20 to display one of the applications displayed in the main monitor 10. For example, if the main monitor 10 displays a text document, a video player, and a Microsoft Service Network (MSN) running on the computer 200 synchronously, the control module 60 may control the secondary monitor 20 to display the text document. The control module 60 further enables the secondary input device 40 corresponding to the secondary monitor 20, and controls the main input device 30 to control the operations on the main monitor 10, and controls the secondary input device 40 to control the operations on the corresponding secondary monitor 20 according to the table stored in the storage module 50.

In the extension mode, the control module 60 controls the secondary monitor 30 and the main monitor 10 to cooperatively display an integral image of the applications running on the computer 200. The control module 60 further disables the secondary input device 40 corresponding to the secondary monitor 20, and controls the main input device 30 to control the operations both on the secondary monitor 20 and the main monitor 10 according to the table stored in the storage module 50.

In the clone mode, the control module 60 controls the main monitor 10 to display the applications running on the computer 200, and controls the secondary monitor 30 to synchronously display the same content with the main monitor 10. The control module 60 further disables the secondary input device 40 corresponding to the secondary monitor 20, and controls the main input device 30 to operate both of the secondary monitor 20 and the main monitor 10.

If the number of the secondary monitors 20 of the system 100 is more than one, different secondary monitor 20 may be selected to display in different display modes.

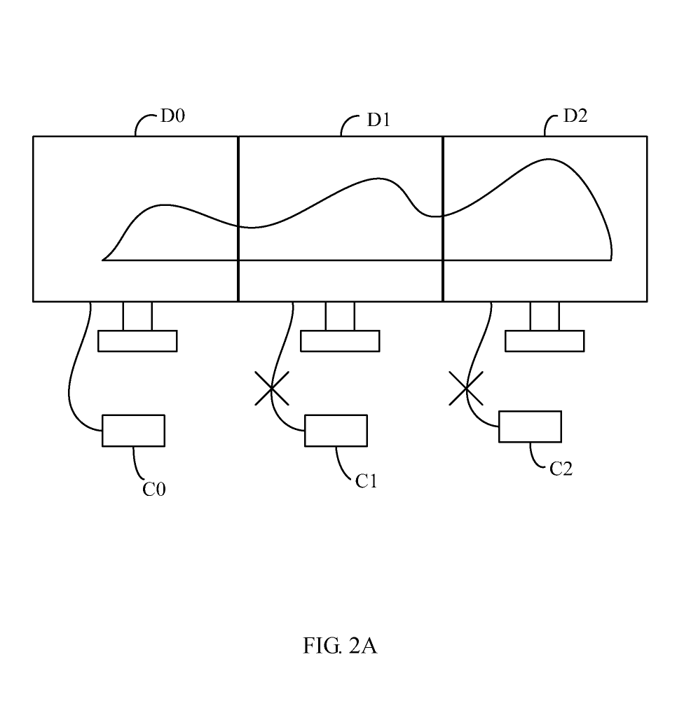

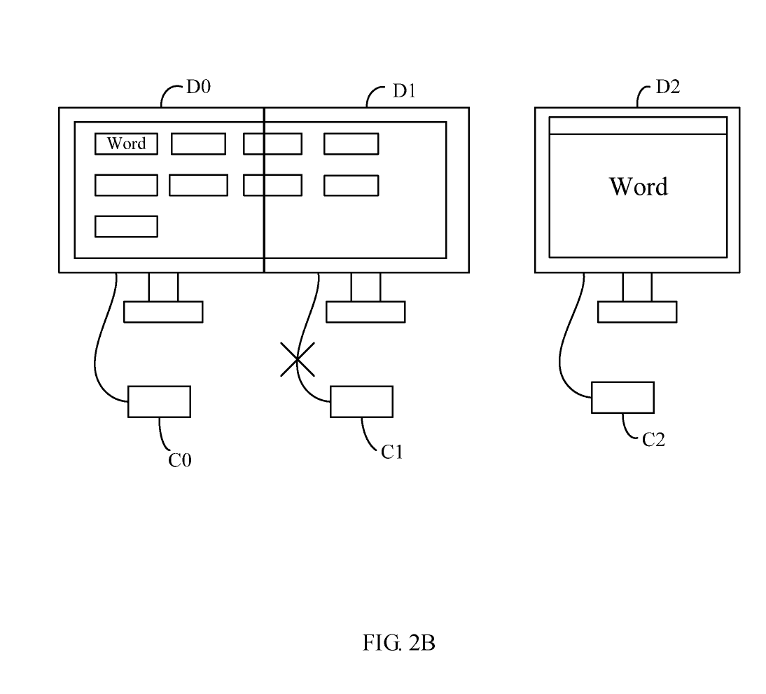

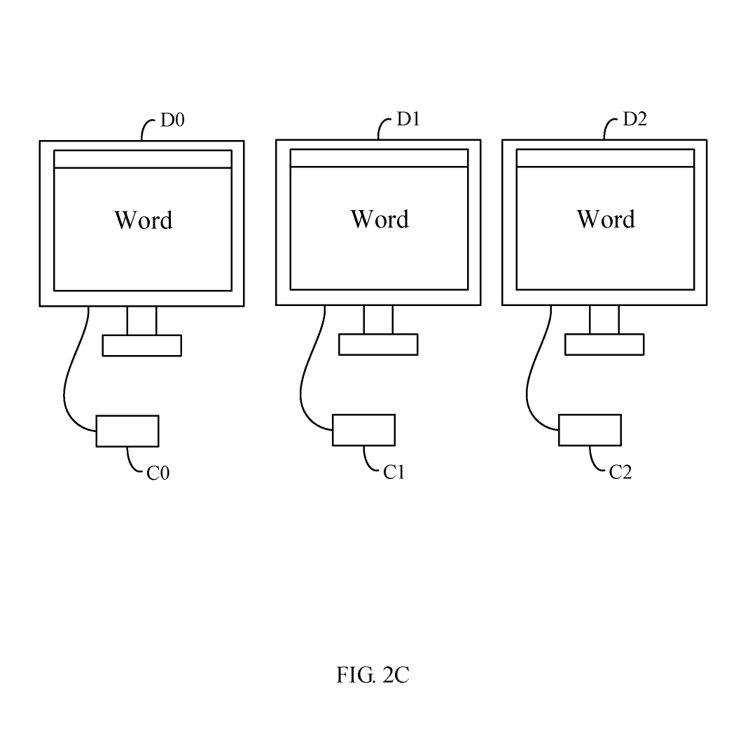

Examples as shown in FIGS. 2A-2C are given below to expressly describe the present disclosure. The multi-monitor display system 100 includes a main monitor whose unique identifier is D0, two secondary monitors whose unique identifier are respectively D1 and D2, a main input device whose unique identifier is C0, and two secondary input devices whose unique identifier are respectively C1 and C2.

When an operator of the system 100 operates the main input device 30 to select the two secondary monitors D1 and D2 both to display in the extension mode, the control module 60 responds to the operator input to control the two secondary monitors D1 and D2 and the main monitor 10 cooperatively display an integral user interface of the computer 200, shown as FIG. 2A, the control module 60 further disables the secondary input devices C1 and C2 which respectively corresponding to the secondary monitor D1 and D2, and controls the main input device 30 to operate the two secondary monitors D1 and D2 and the main monitor 10.

When the operator of the system 100 operates the main input device 30 to select the secondary monitor C1 displays in the extension mode and the secondary monitor C2 displays in the hierarchical mode, the control mode 60 responds to the operator input to control the main monitor D0 and the secondary monitor D1 cooperatively display an integral user interface and the applications in the user interface, and further to control the secondary monitor D2 displays one of the above application, see FIG. 2B. The control module 60 further disables the secondary input device C1 which is corresponded to the secondary monitor D1, enables the secondary input device C2 which is corresponded to the secondary monitor D2, further controls the main monitor D0 and the secondary monitor D1 both to be operated by the main input device C0, and controls the secondary monitor D2 to be operated by the secondary input device C2.

When the operator of the system 100 selects the two secondary monitors D1 and D2 both to display in the clone mode, the control module 60 responds to the operator input to control the two secondary monitors D1 and D2 synchronously displays the same content with the main monitor D0, shown as FIG. 2C, the control module 60 further disables the secondary input devices C1 and C2 corresponding to the secondary monitors D1 and D2, and controls all of the two secondary monitors D1 and D2 and the main monitor 10 to be operated by the main input device 30.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A multi-monitor display system adapted to a single computer, comprising:
a main monitor configured to display applications running in the computer;
at least one secondary monitor;
a main input device connected to the main monitor, wherein the main input device controls operations of the main monitor;
at least one secondary input device respectively connected to the at least one secondary monitor, wherein each of the at least one secondary input device comprises an enable state and a disable state;
a storage module storing a plurality of display modes of the main monitor and the at least one secondary monitor, and a table, wherein the table defines display contents of the main monitor and the at least one secondary monitor in each display mode, and which of the at least one secondary input device is enabled in each display mode, and further defines which of the at least one secondary monitor can be operated by the enabled input device in a corresponding one of the display modes; and
a control module configured to control the main monitor and the enabled one(s) of the at least one secondary monitor to display in the display contents according to a display mode selected by an operator, and further to control the corresponding at least one secondary input device connected to the at least one secondary monitor to switch between the enabled state and the disabled state according to the display mode.

2. The multi-monitor display system as described in claim 1, wherein the main input device is further configured to be operated by the operator of the system to select the display mode for the main monitor and the at least one secondary monitor.

3. The multi-monitor display system as described in claim 2, wherein the display modes stored in the storage module comprises a hierarchical mode, an extension mode, and a clone mode;
in the hierarchical mode, the control module controls the main monitor to display all the applications running on the computer, controls the enabled one(s) of the at least one secondary monitor to display one of the applications displayed in the main monitor, and further enables the secondary input device corresponding to the enabled one(s) of the at least one secondary monitor, and controls the main input device to control the operations on the main monitor, and controls the secondary input device corresponding to the enabled one(s) of the at least one secondary monitor to control the operations on enabled one(s) of the at least one the secondary monitor;
in the extension mode, the control module controls enabled one(s) of the at least one of the secondary monitor and the main monitor to cooperatively display an integral image of the applications running on the computer, and further disables the secondary input device corresponding to the enabled one(s) of the at least one of the secondary monitor, and controls the main input device to control the operations both on the enabled one(s) of the at least one of the secondary monitor and the main monitor; and
in the clone mode, the control module controls the main monitor to display the applications running on the computer, controls the enabled one(s) of the at least one of secondary monitor to synchronously display the same content with the main monitor, and disables the secondary input device corresponding to the enabled one(s) of the at least one of the secondary monitor, and controls the main input device to control the operations both on the enabled one(s) of the at least one of the secondary monitor and the main monitor.

4. The multi-monitor display system as described in claim 3, wherein the main monitor, each of the at least one secondary monitor, the main input device, and each of the at least one secondary input device are designated with a unique identifier, and the control module recognizes the main monitor, the at least one secondary monitor, the main input device, and the at least one secondary input device by the unique identifier.

5. The multi-monitor display system as described in claim 1, wherein the main input device and the at least one secondary input device are one kind of the mouse, keyboards, and touch panels.
